(19) United States
(12) Patent Application Publication
(10) Pub. No.: US 2022/0189481 A1
(43) Pub. Date: Jun. 16, 2022

(54) ELECTRONIC DEVICE AND CONTROL METHOD FOR SAME

(71) Applicant: SAMSUNG ELECTRONICS CO., LTD., Suwon-si (KR)

(72) Inventor: Yury USHAKOV, Suwon-si (KR)

(73) Assignee: SAMSUNG ELECTRONICS CO., LTD., Suwon-si (KR)

(21) Appl. No.: 17/689,406

(22) Filed: Mar. 8, 2022

Related U.S. Application Data
(63) Continuation of application No. PCT/KR2020/011675, filed on Sep. 1, 2020.

(30) Foreign Application Priority Data
Sep. 9, 2019 (KR) 10-2019-0111761

(51) Int. Cl. G10L 15/22; G10L 15/02; G10L 15/16; G06F 3/16; G10L 25/51; G10L 15/06

(52) U.S. Cl. CPC G10L 15/22; G10L 15/02; G10L 15/16; G10L 2015/223; G10L 25/51; G10L 15/063; G06F 3/167

(57) ABSTRACT

An electronic apparatus and control method are disclosed. An electronic apparatus includes a memory including at least one instruction, and a processor configured to be connected to the memory and control the electronic apparatus, wherein the processor is configured to receive an audio signal including voice, separate the received audio signal to acquire a plurality of signal frames, convert the plurality of signal frames into a plurality of feature data, normalize the plurality of feature data to acquire a plurality of normalized data, and input the plurality of normalized data into a neural network model learned to identify whether a trigger voice is included in the audio signal.

### CROSS-REFERENCE TO RELATED APPLICATION

This application is a U.S. National Stage Application, which claims the benefit under 35 U.S.C. § 371 of International Patent Application No. PCT/KR2020/011675, filed Sep. 1, 2020 which claims the benefit of KR 10-2019-0111761, filed Sep. 9, 2019, the contents of both of which are incorporated by reference herein in their entirety.

### BACKGROUND

### Field

The disclosure relates to an artificial intelligence (AI) system utilizing a machine learning algorithm and its application.

### Description of the Related Art

An artificial intelligence system is a computer system that implements human-level intelligence, and it is a system in which a machine learns and determines on its own, and a recognition rate improves the more it is used.

Artificial intelligence technology comprises of machine learning (deep learning) technology that uses an algorithm that classifies/learns features of input data on its own, and element technology that uses machine learning algorithms to simulate functions such as cognition and identification of human brain.

The element technologies may include at least one of, for example, linguistic understanding technology for recognizing human language/text, visual understanding technology for recognizing objects like human eyes, reasoning/prediction technology for logically reasoning and predicting by identifying information, knowledge expression technology for processing human experience information as knowledge data, and motion control technology for controlling autonomous driving of vehicles and movement of robots.

Linguistic understanding is a technology for recognizing and applying/processing human language/text, and includes natural language processing, machine translation, dialogue system, question and answer, voice recognition/synthesis, or the like.

Recently, a technology for controlling the electronic apparatus using a user voice input through a microphone or the like is used in various electronic apparatuses. For example, a smart TV may change a channel or adjust a volume through a user voice, and a smartphone may acquire various information through the user voice.

Particularly, while a voice recognition engine of the electronic apparatus is deactivated, the voice recognition engine may be activated using the user voice. In this case, the user voice for activating the voice recognition engine may be referred to as a trigger voice. In other words, in order to identify the trigger voice from the user's spoken voice and activate the voice recognition engine corresponding to the identified trigger voice, a need for a technology capable of improving the recognition rate of the trigger voice is increasing.

In addition, when a plurality of voice recognition engines are used in the electronic apparatus, the user must press different buttons on a remote controller or input different trigger signals in order to use a specific voice recognition engine, a need for neural network models that can identify a number of trigger signals, regardless of the number of trigger signals, is increasing.

### SUMMARY

According to an embodiment of the disclosure, a method of controlling an electronic apparatus includes receiving an audio signal including voice, separating the received audio signal to acquire a plurality of signal frames, converting the plurality of signal frames into a plurality of feature data, normalizing the plurality of feature data to acquire a plurality of normalized data, and inputting the plurality of normalized data into a neural network model learned to identify whether a trigger voice is included in the audio signal.

According to an embodiment of the disclosure, an electronic apparatus includes a memory storing at least one instruction, and a processor configured to be connected to the memory and control the electronic apparatus, wherein the processor is configured to receive an audio signal including voice, separate the received audio signal to acquire a plurality of signal frames, convert the plurality of signal frames into a plurality of feature data, normalize the plurality of feature data to acquire a plurality of normalized data, and input the plurality of normalized data into a neural network model learned to identify whether a trigger voice is included in the audio signal.

### BRIEF DESCRIPTION OF DRAWINGS

The above and/or other aspects of the disclosure will be more apparent by describing various embodiments of the disclosure with reference to the accompanying drawings, in which:

FIG. 1 is a block diagram schematically illustrating a configuration of an electronic apparatus according to an embodiment;

FIG. 2 is a flowchart illustrating an overall process of identifying a trigger voice included in a voice signal according to an embodiment;

FIG. 3A is a view illustrating that labeling is performed on a voice signal including a first trigger voice according to an embodiment;

FIG. 3B is a view illustrating that labeling is performed on a voice signal including a second trigger voice according to an embodiment;

FIG. 4A is a graph of feature data, according to an embodiment;

FIG. 4B is a graph of normalized data in which feature data is normalized, according to an embodiment;

FIG. 5A is a view illustrating that a UI indicating a first voice recognition engine corresponding to a first trigger voice is displayed on a display;

FIG. 5B is a view illustrating that a UI indicating a second voice recognition engine corresponding to a second trigger voice is displayed on a display;

FIG. 6 is a flowchart for identifying a trigger voice according to an embodiment;

FIG. 7 is a sequence view illustrating an operation between an electronic apparatus and a server according to an embodiment;

FIG. 8 is a block view illustrating a detailed configuration of an electronic apparatus according to an embodiment;

FIG. 9A is a view illustrating an electronic apparatus including a microphone and a display;

FIG. 9B is a view illustrating an electronic apparatus including a display and receiving an audio signal from an external device; and

FIG. 9C is a view illustrating an electronic apparatus including a microphone and transmitting a control signal to an external display.

### DETAILED DESCRIPTION

Hereinafter, exemplary embodiments will be described in detail with reference to accompanying drawings.

The disclosure has been made based on the needs described above, and an object of the disclosure is to provide an electronic apparatus capable of improving a recognition rate of a trigger voice and identifying a trigger voice for a plurality of voice recognition engines, and a control method thereof.

Through the electronic apparatus and the control method of the electronic apparatus as described above, a recognition rate of a trigger voice may be improved, and a trigger voice for a plurality of voice recognition engines may be identified.

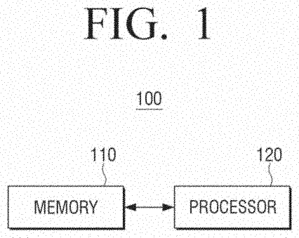

FIG. 1 is a block view illustrating an electronic apparatus 100 according to an embodiment. The electronic apparatus according to various embodiments of the disclosure may be implemented as a user terminal device or a home appliance, but this is only an example and may be implemented as at least one server. As illustrated in FIG. 1, the electronic apparatus 100 may include a memory 110 and a processor 120.

The memory 110 may store various programs and data necessary for the operation of the electronic apparatus 100. To be specific, memory 110 may include at least one button. The processor 120 may control an overall operation of the electronic apparatus 100 by using various types of programs stored in the memory 110.

The memory 110 may be implemented as a non-volatile memory, a volatile memory, a flash memory, a hard disk drive (HDD) or a solid state drive (SDD). The memory 110 may be accessed by the processor 120, and perform readout, recording, correction, deletion, update, and the like, on data by the processor 120. According to an embodiment, the term of the storage may include the memory 110, read-only memory (ROM) (not illustrated) and random access memory (RAM) (not illustrated) within the processor 120, and a memory card (not illustrated) attached to the electronic apparatus 100 (e.g., micro secure digital (SD) card or memory stick). Further, the memory 110 may store programs, data, and so on to constitute various screens to be displayed on the display area of the display.

The memory 110 may store an audio signal. The audio signal may include a voice, and it may be identified whether the audio signal includes a trigger voice through the electronic apparatus 100 according to the disclosure.

The memory 110 may store the learned neural network model. The neural network model according to the disclosure is a neural network model learned to identify a trigger voice and may be implemented as a Recurrent Neural Network (RNN) or a Deep Neural Network (DNN), which will be described below in detail.

Functions related to artificial intelligence according to the disclosure may be operated through the processor 120 and the memory 110.

The processor 120 may include one or a plurality of processors. In this case, the one or more processors may be a general-purpose processor such as a central processing unit (CPU), an application processor (AP), or the like, graphics-only processor such as a graphics processing unit (GPU), visual processing unit (VPU), or the like, or an AI-only processor such as a neural processing unit (NPU).

One or a plurality of processors control to process input data according to a predefined operation rule or artificial intelligence model stored in the memory. The predefined operation rule or artificial intelligence model is characterized in that it is generated through learning. Here, being made through learning means that a predefined operation rule or artificial intelligence model with desired features is generated by applying a learning algorithm to a plurality of learning data. Such learning may be performed in the device itself on which the artificial intelligence according to the disclosure is performed, or may be performed through a separate server/system.

The artificial intelligence model may be composed of a plurality of neural network layers. Each layer has a plurality of weight values, and a layer operation is performed through an operation result of a previous layer and an operation of the plurality of weight values. Examples of neural networks include convolutional neural network (CNN), deep neural network (DNN), recurrent neural network (RNN), restricted Boltzmann machine (RBM), deep belief network (DBN), bidirectional recurrent deep neural network (BRDNN) and deep Q-network, and the neural network in the disclosure is not limited to the example described above, except as otherwise specified.

The processor 120 may be electrically connected to the memory 110 to control overall operation of the electronic apparatus 100. Specifically, the processor 120 may control the electronic apparatus 100 by executing at least one command stored in the memory 110.

The processor 120 according to the disclosure may divide the received audio signal into a plurality of signal frames. In other words, the processor 120 may separate the audio signal in frame units and acquire (obtain) a plurality of signal frames corresponding to the audio signal. In addition, the processor 120 may convert each of the plurality of signal frames into data suitable for input to the neural network model. In other words, the processor 120 may convert the audio signal into data suitable for input to the neural network model according to the disclosure, and input the converted data into the neural network model to identify whether the audio signal includes a trigger voice.

The neural network model according to the disclosure may be implemented as a recurrent neural network (RNN) as a neural network model learned to identify a trigger voice. The RNN model is an artificial intelligence neural network model, meaning an artificial intelligence neural network model with a loop added in a hidden layer. However, the disclosure is not limited thereto, and the neural network model learned to identify the trigger voice according to the disclosure may be implemented as a deep neural network (DNN).

In the neural network model according to the disclosure, learning may be performed based on first data including a trigger voice and second data not including a trigger voice. In the learning of the neural network model according to the disclosure, the neural network model may be learned by labeling only the first data including the trigger voice, and the neural network model learned based on the first data and the second data may identify only the trigger voice for one voice recognition engine.

The processor 120 may convert each of the plurality of signal frames acquired to convert the audio signal into data suitable for input to the learned neural network model into a plurality of first feature data. As for the plurality of first feature data, features may be extracted in the plurality of signal frames through methods such as Short Time Fourier Transform (STFT) Coefficients, Mel-frequency Cepstral coefficients (MFCC), liner predictive coding (LPC), and wavelet coefficients to acquire the plurality of first feature data.

The processor 120 may acquire a plurality of normalized data by normalizing the plurality of first feature data. Normalization refers to a process of converting data into data suitable for input to a neural network model, and the processor 120 may input a plurality of normalized data to a neural network model learned to identify a trigger voice to identify whether the signal contains a trigger voice.

The processor 120 may acquire a plurality of normalized data by normalizing the plurality of first feature data. However, the disclosure is not limited thereto, and the processor 120 may acquire a plurality of second feature data by adding artificial noise to the plurality of first feature data, and acquire normalize the plurality of second feature data to acquire a plurality of normalized data. In other words, the processor 120 may track a noise level of the audio signal in order to add artificial noise to the first feature data. The processor 120 may acquire second feature data by adding the artificial noise to the first feature data based on the tracked noise level. The noise level tracking according to the disclosure may be performed through a minima-controlled recursive averaging (MCRA) method based on a plurality of signal frames and a plurality of first feature data, but is not limited thereto. In addition, if the first feature data is acquired through the Short Time Fourier Transform (STFT) Coefficients method, a process of adding artificial noise to the first feature data may be the same as the spectral whitening method used to add the artificial noise. As described above, when artificial noise is added to the plurality of first feature data, the processor 120 may more clearly identify information on the trigger voice included in the first feature data, such that a recognition rate for the trigger voice may be improved.

Although the embodiment described above has been described as a neural network model that identifies a trigger voice for one voice recognition engine, this is only an example, and the neural network model according to the disclosure may identify trigger voices for a plurality of voice recognition engines. In other words, when the neural network model is learned based on third data not including a trigger voice, fourth data including the first trigger voice, and fifth data including the second trigger voice, the neural network model may recognize trigger voices with respect to two voices. A first trigger voice may be a trigger voice for activating the first voice recognition engine, and a second trigger voice may be a trigger voice for activating the second voice recognition engine. In addition, the neural network model may be learned by labeling only the fourth data and the fifth data, and different labeling may be applied to the fourth data and the fifth data such that the neural network model may be learned. Accordingly, the neural network model learned based on the first data and the second data may identify a trigger voice for one voice recognition engine, and the neural network model learned based on the third to fifth data may identify trigger voices with respect to two voice recognition engines. In other words, the neural network model according to the disclosure may identify trigger voices for a plurality of voice recognition engines according to learning data acquired by learning the neural network model.

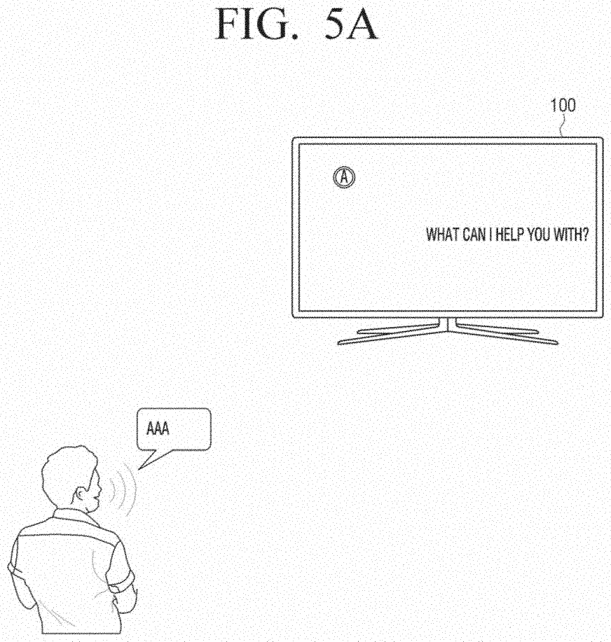

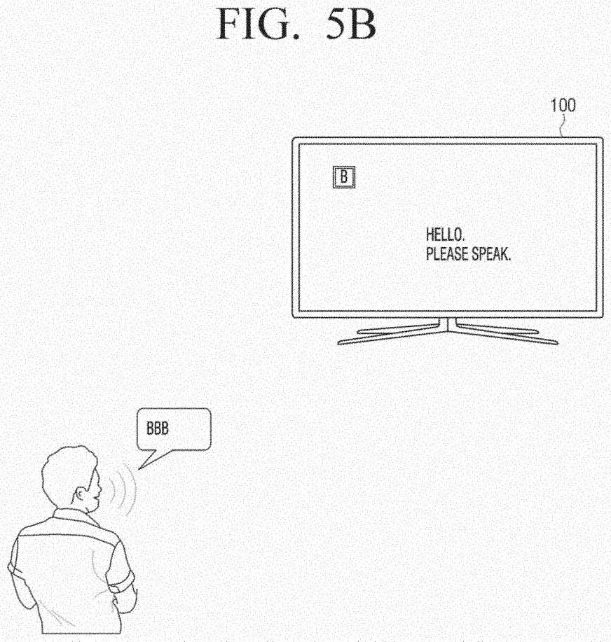

The processor 120 may activate the first voice recognition engine when it is identified that the audio signal includes the first trigger voice, and activate the second voice recognition engine when it is identified that the audio signal includes the second trigger voice. In addition, the processor 120 may control to display a UI indicating a voice recognition engine corresponding to a trigger voice identified among the first voice recognition engine and the second voice recognition engine on the display. The UI indicating the voice recognition engine will be described below with reference to FIGS. 5A and 5B.

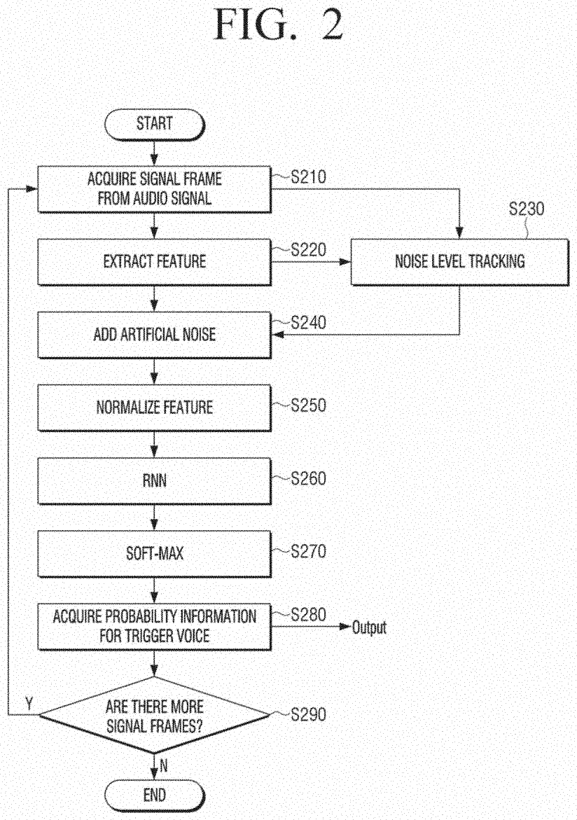

FIG. 2 is a flowchart illustrating an overall process of identifying a trigger voice included in a voice signal according to an embodiment of the disclosure.

Referring to FIG. 2, the electronic apparatus 100 may acquire a signal frame from an audio signal (S210). The audio signal may include the user voice, may be received through a microphone provided in the electronic apparatus 100, or may be acquired through a microphone provided in a smartphone or remote controller connected to the electronic apparatus 100 and may be received from the smartphone or remote controller. In addition, the electronic apparatus 100 may acquire a plurality of signal frames by separating the received audio signal.

In addition, the electronic apparatus 100 may acquire first feature data corresponding to each signal frame by extracting a feature from each signal frame (S220). As described above, as for the first feature data, a feature may be extracted and acquired from each signal frame through a method such as short-time Fourier transform (STFT) coefficients, Mel-frequency Cepstral Coefficients (MFCC), liner predictive coding (LPC), and wavelet coefficients.

The electronic apparatus 100 may perform artificial noise tracking (S230) based on the signal frame and the first feature data, and add artificial noise to the first feature data based on the tracked noise level (S240), second feature data may be acquired. A process of tracking artificial noise may be performed through a minima-controlled recursive averaging (MCRA) method, but is not limited thereto.

The electronic apparatus 100 may acquire normalized data by normalizing the second feature data (S250), and may input the normalized data into a recurrent neural network (RNN) model (S260). In other words, the electronic apparatus 100 may convert the audio signal into data suitable for input to the RNN model through the process described above (S210 to S250).

The electronic apparatus 100 may input data output from the RNN model to a soft-max layer (S270), and acquire probability information on whether a trigger voice is included in the audio signal (S280). The soft-max layer may mean a layer for converting data output from the RNN into a probability form. When data output from the RNN model is input to the soft-max layer, probability information on whether the audio signal includes a trigger voice may be acquired.

In addition, when a signal frame further exists in the audio signal (S290-Y), the electronic apparatus 100 may repeat the process described above for the remaining signal frame. In other words, the electronic apparatus 100 may identify whether a trigger voice is included in the audio signal by separating the audio signal into a plurality of signal frames and performing the process described above for each of the plurality of signal frames. When there is no more signal frame in the audio signal (S290-N), the electronic apparatus 100 may terminate the process described above.

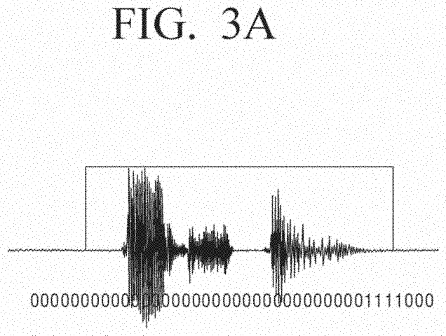

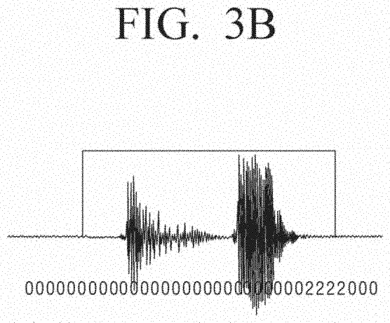

FIGS. 3A and 3B are views illustrating labeling of a voice signal including a trigger voice according to an embodiment of the disclosure. Specifically, FIG. 3A shows labeling on a voice signal including a first trigger voice, and FIG. 3B shows labeling on a voice signal including a second trigger voice, according to an embodiment of the disclosure.

The voice signal illustrated in FIG. 3A includes the first trigger voice, and a first labeling such as 1111 is applied to a frame at the end of the first trigger voice. In other words, referring to FIG. 3A, four frames in a part where the first trigger voice ends may be labeled as 1, and each of the frames in the remaining part may be labeled as 0. However, the disclosure is not limited thereto, and 3 to 5 frames at the end of the first trigger voice may be labeled as 1. The neural network model according to the disclosure may be learned based on fourth data including a plurality of labeled first trigger voices. In other words, the fourth data may include a plurality of first labeled data in a plurality of voice signals in which a first trigger voice is uttered by a plurality of speakers.

The voice signal illustrated in FIG. 3B includes a second trigger voice, and is labeled as 2222 in the frame at the end of the second trigger voice. In other words, the neural network model may be learned based on fifth data, in which four frames of a part where the second trigger voice ends may be labeled as 2, and each of the frames of the remaining part may be labeled as 0. In other words, the neural network model according to the disclosure may be learned based on fifth data including a plurality of labeled second trigger voices. In other words, the fifth data may include a plurality of data labeled second in a plurality of voice signals in which a second trigger voice is uttered by a plurality of speakers.

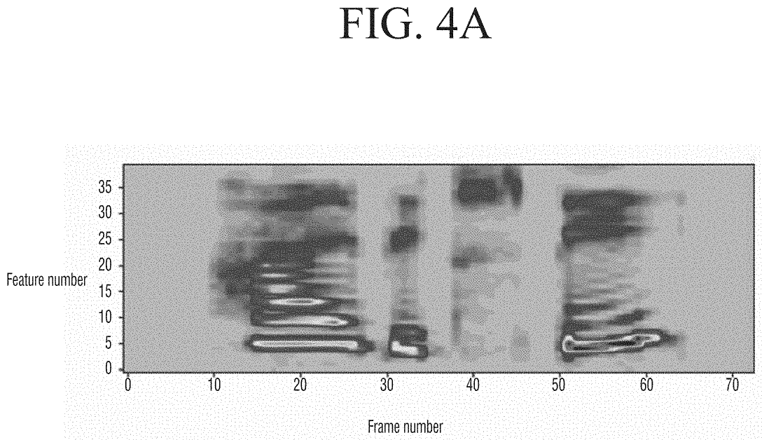

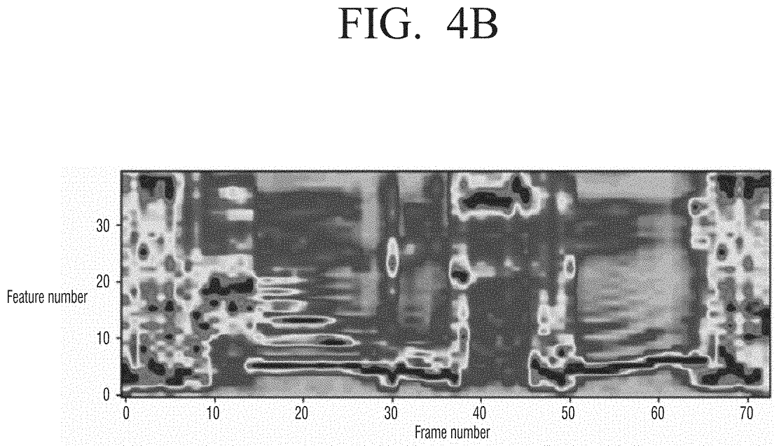

FIG. 4A is a graph illustrating feature data according to an embodiment of the disclosure. The graph illustrated in FIG. 4A is a graph illustrating second feature data acquired by adding artificial noise to first feature data. Specifically, the graph of FIG. 4A illustrates a Mel-filtered spectrum in which a feature is extracted by the MFCC method for each signal frame, and the acquired feature is displayed for each frame unit.

FIG. 4B is a graph illustrating normalized data in which the feature data illustrated in FIG. 4A is normalized. Specifically, the graph illustrated in FIG. 4B is a graph showing normalized data acquired by normalizing the second feature data. In other words, the normalized data illustrated in 4b may be data with a fixed range (e.g., [0,1] or [−1,1]) to be suitable for input into the RNN model. In other words, the normalized data of FIG. 4B is data acquired by adding artificial noise to the first feature data and performing normalization, and a trigger voice included in the audio signal may be more clearly identified through the normalized data.

FIG. 5A is a view illustrating that a UI indicating a first voice recognition engine corresponding to a first trigger voice is displayed on a display.

When the user utters a first trigger voice AAA, the electronic apparatus 100 may receive an audio signal including the user's utterance and identify that the audio signal includes the first trigger voice AAA. The first voice recognition engine may be activated by the first trigger voice AAA, and when it is identified that the audio signal includes the first trigger voice AAA, the electronic apparatus 100 may activate the first voice recognition engine corresponding to the first trigger voice AAA to display a UI indicating that the first voice recognition engine is activated on the display. The UI indicating that the first voice recognition is activated may include a logo or image A indicating the first voice recognition engine and a guide message requesting the user's utterance. In other words, when the user utters the first trigger voice AAA, the electronic apparatus 100 may activate the first voice recognition engine corresponding to the first trigger voice AAA, and display the UI indicating that the first voice recognition engine is activated on the display such that the user may utilize the first voice recognition engine through the UI displayed on the display.

FIG. 5B is a view illustrating that a UI indicating a second voice recognition engine corresponding to a second trigger voice is displayed on a display.

When the user utters the second trigger voice BBB, the electronic apparatus 100 may receive an audio signal including the user voice and identify that the audio signal includes the second trigger voice BBB. The second voice recognition engine may be activated according to the second trigger voice BBB, and when it is identified that the audio signal includes the second trigger voice BBB, the electronic apparatus 100 may activate the second voice recognition engine corresponding to the second trigger voice BBB to display a UI indicating that the second voice recognition engine. The UI indicating that the second voice recognition is activated may include a logo or image B indicating the second voice recognition engine and a guide message requesting the user utterance. In other words, when the user utters the second trigger voice BBB, the electronic apparatus 100 may activate the second voice recognition engine corresponding to the second trigger voice BBB, and the UI indicating that the second voice recognition engine is activated on the display, such that the user may utilize the second voice recognition engine through the UI displayed on the display.

In other words, the electronic apparatus 100 according to the disclosure may identify trigger voices for different voice recognition engines by using the neural network model learned to identify the trigger voices, and a voice recognition engine corresponding to the trigger voice identified according to the trigger voice may be activated.

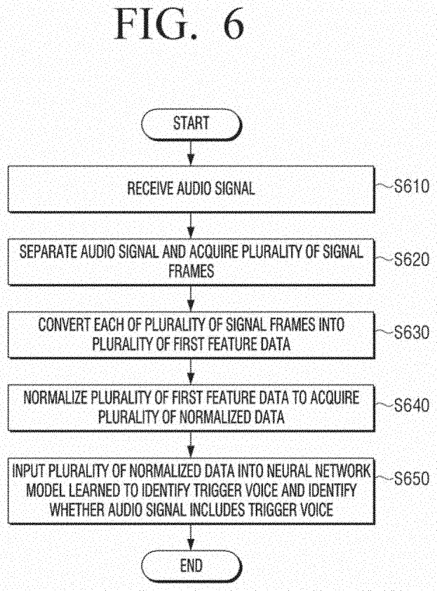

FIG. 6 is a flowchart for identifying a trigger voice according to an embodiment of the disclosure.

Referring to FIG. 6, the electronic apparatus may receive an audio signal (S610). The audio signal includes a user voice, and the electronic apparatus may identify whether a trigger voice is included in the received audio signal.

When the audio signal is received, the electronic apparatus may acquire a plurality of signal frames by separating the audio signal (S620). Specifically, the electronic apparatus may acquire a plurality of signal frames corresponding to the audio signal by separating the audio signal in frame units.

The electronic apparatus may convert each of the plurality of signal frames into a plurality of first feature data (S630). The plurality of first feature data may be acquired by extracting features from a plurality of signal frames through methods such as Short Time Fourier Transform (STFT) Coefficients, Mel-Frequency Cepstral Coefficients (MFCC), Liner Predictive Coding (LPC), and Wavelet Coefficients.

The electronic apparatus may acquire a plurality of normalized data by normalizing the plurality of first feature data (S640). Normalization may refer to a process of transforming data into suitable data for input into a neural network model.

The electronic apparatus may input a plurality of normalized data on which the normalization process has been performed into the learned neural network model to identify the trigger voice, and identify whether the audio signal includes the trigger voice (S650).

The electronic apparatus may convert the audio signal received through the process described above into data suitable for input to the neural network model. In addition, the electronic apparatus may identify whether a trigger voice is included in the audio signal through the plurality of converted normalized data.

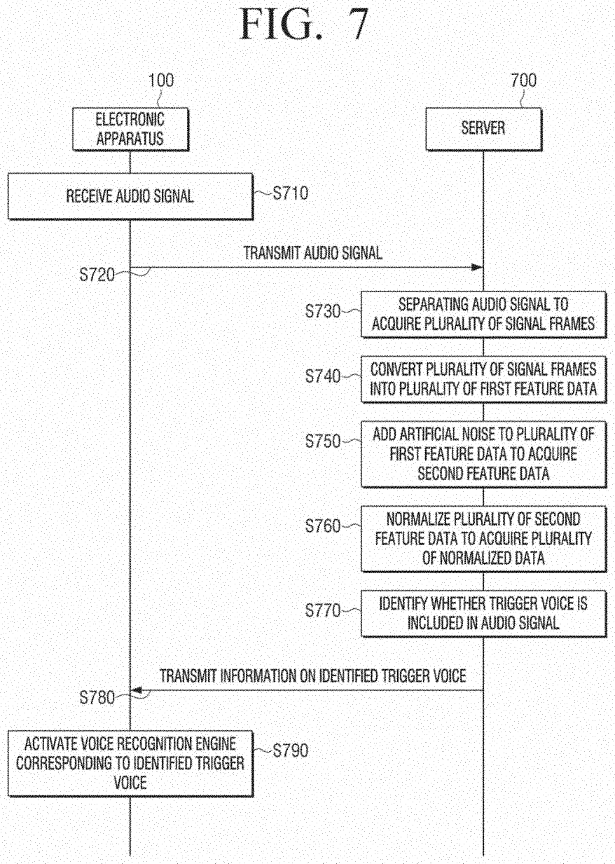

FIG. 7 is a sequence diagram illustrating an operation between an electronic apparatus and a server according to an embodiment of the disclosure.

Referring to FIG. 7, the electronic apparatus 100 may receive an audio signal (S710). The audio signal may include a voice, and an audio signal may be received through a microphone provided in the electronic apparatus 100, or an audio signal acquired from an external device may be received from an external device. Also, the electronic apparatus 100 may transmit the received audio signal to a server 700 (S720). The server 700 disclosed in FIG. 7 is a server for using the neural network model according to the disclosure, and may receive an audio signal from the electronic apparatus 100, identify whether a trigger voice is included in the audio signal through the neural network model, and transmit information on the identified trigger voice to the electronic apparatus 100.

When the audio signal is transmitted from the electronic apparatus 100, the server 700 may acquire a plurality of signal frames by separating the audio signal (S730). The server 700 may convert the plurality of signal frames into the plurality of first feature data (S740). As for the plurality of first feature data, a feature may be extracted from a plurality of signal frames through methods such as Short Time Fourier Transform (STFT) Coefficients, Mel-Frequency Cepstral Coefficients (MFCC), Liner Predictive Coding (LPC), and Wavelet Coefficients to acquire the plurality of first feature data.

The server 700 may acquire a plurality of second feature data by adding artificial noise to the first feature data (S750). The server 700 may track a noise level of the audio signal based on the plurality of signal frames and the plurality of first feature data. The server 700 may acquire second feature data by adding the artificial noise to the first feature data based on the tracked noise level. A process of tracking the noise level according to the disclosure may be performed through a Minima-Controlled Recursive Averaging (MCRA) method, but is not limited thereto.

The server 700 may normalize the plurality of second feature data to acquire a plurality of normalized data (S760), and input the plurality of normalized data into the neural network model to identify whether a trigger voice is included in the audio signal (S770). Also, the server 700 may transmit information on the identified trigger voice to the electronic apparatus 100 (S780).

The electronic apparatus 100 may activate a voice recognition engine corresponding to the identified trigger voice based on the information received from the server 700 (S790).

In other words, as described above, the electronic apparatus may receive an audio signal from the electronic apparatus, transmit the received audio signal to the server, identify whether the server identifies whether the audio signal includes a trigger voice, and the identified information may be transmitted to the electronic apparatus to activate a voice recognition engine corresponding to the triggered voice.

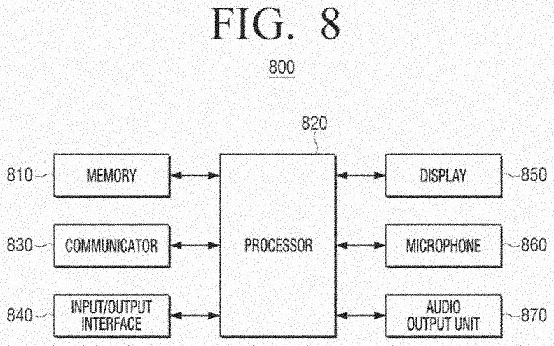

FIG. 8 is a block diagram illustrating a detailed configuration of an electronic apparatus according to an embodiment of the disclosure.

Referring to FIG. 8, the electronic apparatus 800 may include a memory 810, a processor 820, a communicator (comprising circuitry) 830, an input/output interface 840, a display 850, and a microphone 860. Here, since some configurations of the memory 810 and the processor 820 are the same as those illustrated in FIG. 1, duplicate descriptions will be omitted.

The communicator 830 is an element to perform communication with various types of external devices according to various types of communication methods. The communicator 830 may include a Wi-Fi chip, Bluetooth chip, wireless communication chip, NFC chip or the like. The processor 820 may perform the communication with various external devices by using the communicator 830.

Especially, the Wi-Fi chip and Bluetooth chip each performs communication in the Wi-Fi method, and Bluetooth method, respectively. When the Wi-Fi chip or the Bluetooth chip is used, various connection information such as SSID and session key may be first exchanged, communication may be connected by using the connection information, and various information may be exchanged. The wireless communication chip represents a chip which communicates according to various communication standards such as IEEE, ZigBee, 3rd Generation (3G), 3rd Generation Partnership Project (3GPP), Long Term Evolution (LTE), or the like. An near-field communication (NFC) chip refers to a chip that operates in an near field communication (NFC) method that uses the 13.56 MHz band of among various radio frequency-identification (RF-ID) frequency bands such as 135 kHz, 13.56 MHz, 433 MHz, 860-960 MHz, and 2.45 GHz.

The communicator 830 may communicate with an external server, transmit an audio signal to the external server, and receive information on whether a trigger voice is included in the audio signal from the external server.

The input/output interface 840 may input/output at least one of audio and video signals. Especially, the input/output interface 840 may receive an image including at least one of content and UI from an external device, and may output a control command to the external device.

Meanwhile, the input/output interface 840 may be a high definition multimedia interface (HDMI), but this is only an example, and it may be an interface of mobile high-definition link (MHL), universal serial bus (USB), display port (DP), thunderbolt, video graphics array (VGA) port, RGB port, D-subminiature (D-SUB), and digital visual interface (DVI). Depending on implementation, the input/output interface 840 may include a port for inputting and outputting only an audio signal and a port for inputting and outputting only an image signal as separate ports, or may be implemented as a single port for inputting and outputting both an audio signal and an image signal.

Accordingly, the electronic apparatus 800 may receive an audio signal from an external device through the input/output interface 840 or the communicator 250.

The display 850 may display signal-processed image data. Also, the display 850 may display a UI indicating a voice recognition engine corresponding to a trigger voice identified by a control of the processor 820. Specifically, when the neural network model according to the disclosure is learned to identify the first trigger voice and the second trigger voice, a UI indicating a voice recognition engine corresponding to the identified trigger voice among the first voice recognition engine corresponding to the first trigger voice or the second voice recognition corresponding to the second trigger voice may be displayed on the display. Although the electronic apparatus 800 disclosed in FIG. 8 is disclosed as including the display 850, the disclosure is not limited thereto, and the electronic apparatus according to the disclosure may be connected to an external display, and a control signal may be transmitted to the external display to display the UI according to the external display.

A microphone 860 receives an audio signal from the outside. The audio signal may include the user voice, and the user voice may include a trigger voice for activating the voice recognition engine and a command for controlling the electronic apparatus 800 through the voice recognition engine. Although the electronic apparatus 800 disclosed in FIG. 8 is disclosed as including the microphone 860, the disclosure is not limited thereto, and the external electronic apparatus may receive an audio signal, and the electronic apparatus according to the disclosure may receive an audio signal from the external electronic apparatus.

An audio output unit 870 outputs audio data under the control of the processor 820. In this case, the audio output unit 870 may be implemented as a speaker output terminal, a headphone output terminal, and a S/PDIF output terminal. When it is identified that the audio signal includes a trigger voice, the processor 820 may control the display 850 to display a UI indicating a voice recognition engine corresponding to the identified trigger voice, and the audio output unit 870 may output a guide voice requesting the user's utterance to use the voice recognition engine.

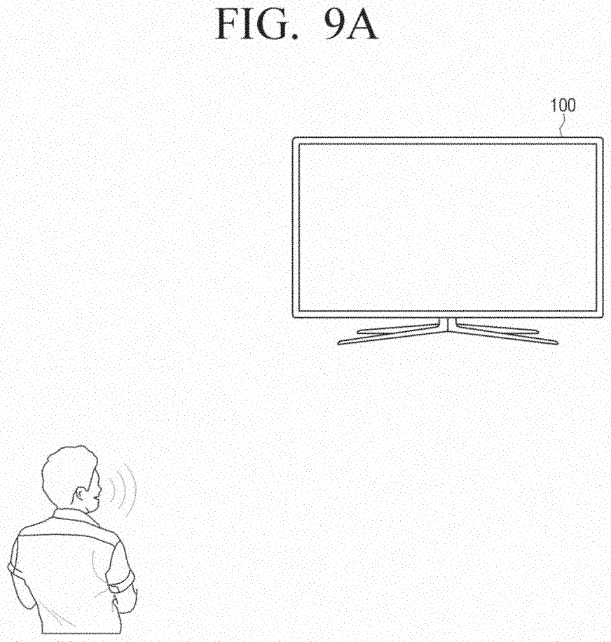

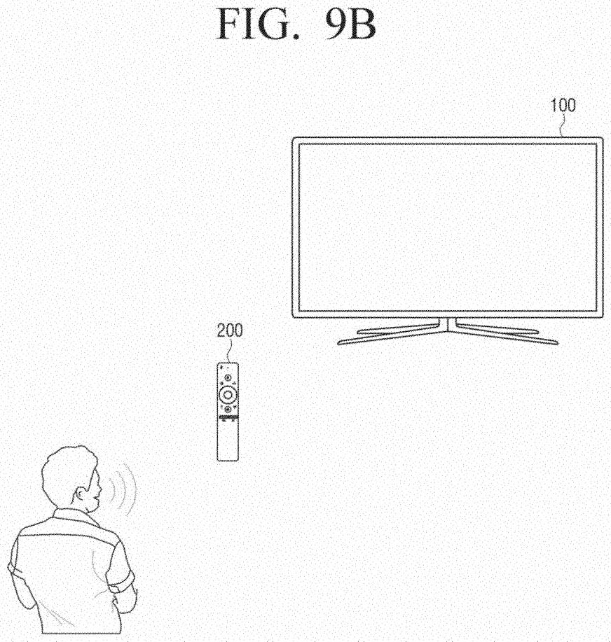

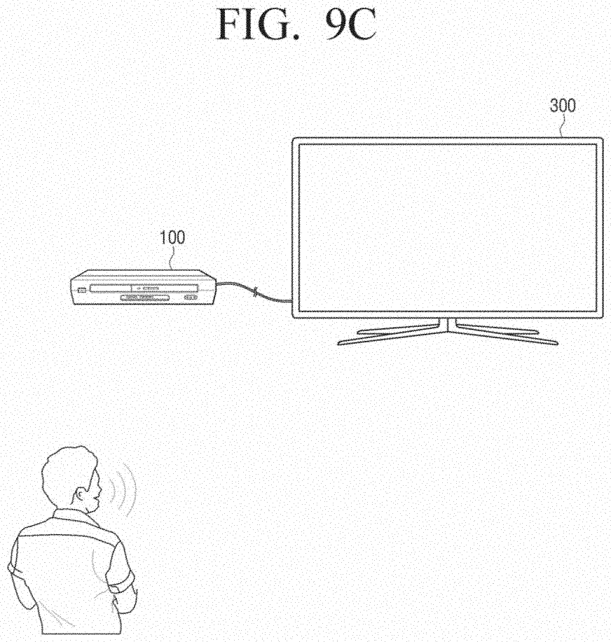

FIGS. 9A to 9C are views illustrating a process of receiving an audio signal including the user voice and identifying whether a trigger voice is included in the audio signal.

Referring to FIG. 9A, the electronic apparatus 100 may include a display and a microphone. In other words, the electronic apparatus 100 according to FIG. 9A may receive the user voice through a microphone included in the electronic apparatus. Accordingly, the electronic apparatus 100 may directly receive the audio signal including the user voice and acquire normalized data corresponding to the received audio signal. In addition, the electronic apparatus 100 may identify whether a trigger voice is included in the received audio signal by inputting normalized data into the neural network model learned to identify the trigger voice. Also, when it is identified that the audio signal includes the trigger voice, the electronic apparatus 100 may activate a voice recognition engine corresponding to the trigger voice and display a UI indicating the activated voice recognition engine on the display.

Referring to FIG. 9B, an audio signal for a user voice is acquired through a remote controller 200, and the electronic apparatus 100 may receive the audio signal acquired from the remote controller 200 for controlling the electronic apparatus 100. In other words, an analog voice signal may be received through a microphone provided in the remote controller 200, and the analog voice signal received from the remote controller may be digitized and transmitted to the electronic apparatus 100.

Although illustrated as the remote controller 200 in FIG. 9B, the disclosure is not limited thereto, and the electronic apparatus 100 may be controlled by a smartphone by installing a remote controller application in a terminal such as a smartphone, or the like, and an audio signal acquired from the smartphone may be received. In other words, in a case of a smartphone in which the remote controller application is installed, the smartphone may receive a voice signal and transmit the received voice signal to the electronic apparatus 100 using Wi-Fi or Bluetooth.

Accordingly, the electronic apparatus 100 may receive the audio signal including the user voice through the remote controller 200 and acquire normalized data corresponding to the received audio signal. In addition, the electronic apparatus 100 may identify whether a trigger voice is included in the received audio signal by inputting normalized data into the neural network model learned to identify the trigger voice. In addition, when it is identified that the audio signal includes the trigger voice, the electronic apparatus 100 may activate a voice recognition engine corresponding to the trigger voice and display a UI indicating the activated voice recognition engine on the display.

Referring to FIG. 9C, the electronic apparatus 100 may include a microphone, and may be connected to an external display 300 and transmit a control signal to the external display 300 to display the UI related to a trigger voice on the external display 300.

An audio signal including a user voice may be received through a microphone of the electronic apparatus 100. Accordingly, the electronic apparatus 100 may directly receive an audio signal including the user voice through the microphone and acquire normalized data corresponding to the received audio signal. In addition, the electronic apparatus 100 may identify whether a trigger voice is included in the received audio signal by inputting normalized data into the neural network model learned to identify the trigger voice. Also, when it is identified that the audio signal includes the trigger voice, the electronic apparatus 100 may activate the voice recognition engine corresponding to the trigger voice and control a UI indicating the activated voice recognition engine to display on the external display 300.

In other words, as described above, the disclosure may be applied to a case in which the electronic apparatus 100 includes a display or not, and when the electronic apparatus 100 does not include a display, a UI related to voice recognition may be displayed in connection with an external display. In addition, it may be applied to cases in which the electronic apparatus 100 includes or does not include a microphone, and when the electronic apparatus 100 does not include a microphone, an audio signal including the user voice from the external remote controller 200 and receive an audio signal from the external remote controller 200.

Various exemplary embodiments described above may be embodied in a recording medium that may be read by a computer or a similar apparatus to the computer by using software, hardware, or a combination thereof. According to the hardware embodiment, exemplary embodiments that are described in the disclosure may be embodied by using at least one selected from Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electrical units for performing other functions. In some cases, embodiments described in the disclosure may be implemented by itself. In a software configuration, various embodiments described in the specification such as a procedure and a function may be embodied as separate software modules. The software modules may respectively perform one or more functions and operations described in the present specification.

Methods of controlling a display apparatus according to various exemplary embodiments may be stored on a non-transitory readable medium. The non-transitory readable medium may be installed and used in various devices.

The non-transitory computer readable recording medium refers to a medium that stores data and that can be read by devices. Specifically, programs of performing the above-described various methods can be stored in a non-transitory computer readable medium such as a CD, a DVD, a hard disk, a Blu-ray disk, universal serial bus (USB), a memory card, ROM, or the like, and can be provided.

In addition, according to an embodiment, the methods according to various embodiments described above may be provided as a part of a computer program product. The computer program product may be traded between a seller and a buyer. The computer program product may be distributed in a form of the machine-readable storage media (e.g., compact disc read only memory (CD-ROM) or distributed online through an application store (e.g., PlayStore™). In a case of the online distribution, at least a portion of the computer program product may be at least temporarily stored or provisionally generated on the storage media such as a manufacturer's server, the application store's server, or a memory in a relay server.

The foregoing exemplary embodiments and advantages are merely exemplary and are not to be construed as limiting the disclosure. The present teaching may be readily applied to other types of apparatuses. Also, the description of the exemplary embodiments of the disclosure is intended to be illustrative, and not to limit the scope of the claims, and many alternatives, modifications, and variations will be apparent to those skilled in the art.

What is claimed is:

1. A method of controlling an electronic apparatus comprising:
receiving an audio signal including voice;
separating the received audio signal to obtain a plurality of signal frames;
converting the obtained plurality of signal frames into a plurality of feature data;
obtaining a plurality of normalized data by normalizing the plurality of feature data; and
identifying whether a trigger voice is included in the audio signal by inputting the plurality of normalized data into a neural network model learned to identify a trigger voice.

2. The method of claim 1,
wherein the neural network model learns to identify a first trigger voice with respect to a first voice recognition engine and a second trigger voice with respect to a second voice recognition engine, and
wherein the method of controlling includes, based on the first trigger voice being identified to be included in the audio signal, activating the first voice recognition engine, and based on the second trigger voice being identified to be included in the audio signal, activating the second recognition engine.

3. The method of claim 2, further comprising:
displaying a UI indicating which among the first voice recognition engine and the second voice recognition engine is associated with an identified trigger voice.

4. The method of claim 1,
wherein the plurality of feature data is a plurality of first feature data and the plurality of normalized data is a plurality of first normalized data, and
the obtaining includes obtaining a plurality of second feature data by adding an artificial noise to the plurality of first feature data t, and obtaining a plurality of second normalized data by normalizing the plurality of second feature data.

5. The method of claim 4, wherein the obtaining the plurality of second feature data comprises:
tracking a noise level of the audio signal; and
based on the tracked noise level, obtaining the plurality of second feature data by adding the artificial noise to the plurality of first feature data.

6. The method of claim 1,
wherein identifying whether the trigger voice is included in the audio signal comprises inputting data output from the neural network model into a soft-max function to obtain probability information on whether the trigger voice is included in the audio signal.

7. The method of claim 1,
wherein the neural network model is configured to be implemented as a recurrent neural network (RNN) or a deep neural network (DNN).

8. The method of claim 1,
wherein the neural network model learns based on first data including the trigger voice and second data not including the trigger voice, and
wherein the neural network model learns by being labeled only with the first data.

9. The method of claim 2,
wherein the neural network model learns based on third data not including the trigger voice, fourth data including the first trigger voice, and fifth data including the second trigger voice, and
wherein the fourth data is first-labelled and the fifth data is second-labelled such that the neural network model is learned.

10. An electronic apparatus comprising:
a memory storing at least one instruction; and
a processor configured to be connected to the memory and control the electronic apparatus,
wherein the processor is configured to:
receive an audio signal including voice,
separate the received audio signal to obtain a plurality of signal frames,
convert the obtained plurality of signal frames into a plurality of feature data,
obtain a plurality of normalized data by normalizing the plurality of feature data, and
identify whether a trigger voice is included in the audio signal by inputting the plurality of normalized data into a neural network model learned to identify the trigger voice.

11. The apparatus of claim 10
wherein the neural network model leans to identify a first trigger voice with respect to a first voice recognition engine and a second trigger voice with respect to a second voice recognition engine, and
wherein the processor is configured to, based on the first trigger voice being identified to be included in the audio signal, activate the first voice recognition engine, and based on the second trigger voice being identified to be included in the audio signal, activate the second recognition engine.

12. The apparatus of claim 10, further comprising:
a display,
wherein the processor is configured to control the display to display a UI indicating which among the first voice recognition engine and the second voice recognition engine is associated with an identified trigger voice.

13. The apparatus of claim 10,
wherein the plurality of feature data is a plurality of first feature data and the plurality of normalized data is a plurality of first normalized data, and
the processor is configured to obtain a plurality of second feature data by adding an artificial noise to the plurality of first feature data, and obtain a plurality of second normalized data by normalizing the plurality of second feature data.

14. The apparatus of claim 13,
wherein the processor is configured to track a noise level of the audio signal, and based on the tracked noise level, obtain the plurality of second feature data by adding the artificial noise to the plurality of first feature data to.

15. The apparatus of claim 10,
wherein the processor is configured to input data output from the neural network model into a soft-max function to obtain probability information on whether the trigger voice is included in the audio signal.
